(19) United States
(12) Patent Application Publication
(10) Pub. No.: US 2013/0008621 A1
(43) Pub. Date: Jan. 10, 2013

(54) PMC FABRIC YARNS WITH IMPROVED VISIBILITY

(76) Inventors: Ashish Sen, Goodview, MN (US); Jürgen Abraham, Nattheim (DE); Brian Good, Summerville, SC (US)

(21) Appl. No.: 13/368,924

(22) Filed: Feb. 8, 2012

Related U.S. Application Data
(63) Continuation-in-part of application No. 13/177,084, filed on Jul. 6, 2011.

(51) Int. Cl. D21G 9/00; C08L 67/00; C08K 5/353; D02G 3/04; D02G 3/22; B82Y 30/00

(52) U.S. Cl. 162/289; 428/401; 428/397; 524/601; 524/94; 977/742; 977/734

(57) ABSTRACT

A PMC fabric includes a plurality of monofilament yarns. At least some of the monofilament yarns have a composition which is a mixture of a thermoplastic resin and an additive to improve yarn visibility. The additive may be, e.g., a UV additive, an IR additive and/or a metal powder additive.

### CROSS REFERENCE TO RELATED APPLICATIONS

This is a continuation-in-part of U.S. patent application Ser. No. 13/177,084, entitled “SEAMING PROCESS FOR PMC FABRIC HAVING MONOFILAMENT YARNS”, filed Jul. 6, 2011, which is incorporated herein by reference.

### BACKGROUND OF THE INVENTION

1. Field of the Invention

The present invention relates to paper machine clothing, and more particularly, to monofilament yarns used in such clothing.

2. Description of the Related Art

A paper machine clothing (PMC) fabric is typically manufactured with a specific set of design and quality specifications for a particular paper machine's performance requirements. These specifications include surface characteristics, open area, void volume, permeability and smoothness, among others.

Flat woven PMC fabrics are seamed after heat setting to form an endless belt. Seaming is the most time-consuming, costly and tedious part of PMC fabric manufacturing. Weft yarns are raveled out on both ends of the fabric, creating a warp fringe. Warp yarns on both ends of the fabric are then woven together one by one using filling yarn. There are many ways of joining the warp ends together to achieve a desired seam strength. Depending on the strength requirements, the seamed area of the PMC fabric can be several inches long.

After seaming, the PMC fabric is given a final heat set to relieve the stresses in the seaming area. The final heat setting temperature is lower than the preliminary heat setting temperature in order not to alter the properties of the PMC fabric that were set during preliminary heat set. After final heat setting, the fabric edges are trimmed to the paper machine width.

During the seaming process, it is common for much of the weaving to be done by hand. It can be difficult for a person to see the individual yarns such as the exposed warp yarns in the fringe area. When the PMC fabric yarn is composed of darker colored (e.g., dark colored resin or resin with dark fillers) or fine diameter yarns, e.g., fine diameter yarns below 0.25 mm, the exposed warp yarns in the fringe area can be even more difficult to see with the human eye. This compounds the difficulty and expense of the seaming process.

What is needed in the art is a yarn for a PMC fabric which improves yarn visibility to aid in applications such as allowing fringe ends to be more easily woven together.

### SUMMARY OF THE INVENTION

The present invention provides a monofilament yarn for a PMC fabric with an additive that makes the yarn ends easily visible using a light or radiation source. The mechanical properties of the monofilament yarn are not altered by the addition of the additive.

The present invention in one form is directed to a PMC fabric including a plurality of monofilament yarns. At least some of the monofilament yarns have a composition which is a mixture of a thermoplastic resin and an additive to improve yarn visibility.

An advantage of the present invention is that the fringed ends of the fabric can be easily seen under a light or radiation source by a person during the seaming process.

Another advantage of the present invention is that the addition of the additive does not substantially alter the physical properties of the monofilament yarn.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a fragmentary, perspective view of a portion of a fabric including an embodiment of a monofilament yarn of the present invention;

FIG. 2 is an illustration of absorption and emission spectra;

FIG. 3 is an illustration of the principle of fluorescence;

FIG. 4 is a schematic view of a portion of a fabric with the fringed end being illuminated with a UV light;

FIG. 5 is a flow chart illustrating an embodiment of the method of making monofilament yarns according to the present invention; and

FIG. 6 is a flow chart illustrating an embodiment of the seaming process for a PMC fabric according to the present invention.

Corresponding reference characters indicate corresponding parts throughout the several views. The exemplification set out herein illustrates an embodiment of the invention and such exemplification is not to be construed as limiting the scope of the invention in any manner.

### DETAILED DESCRIPTION OF THE INVENTION

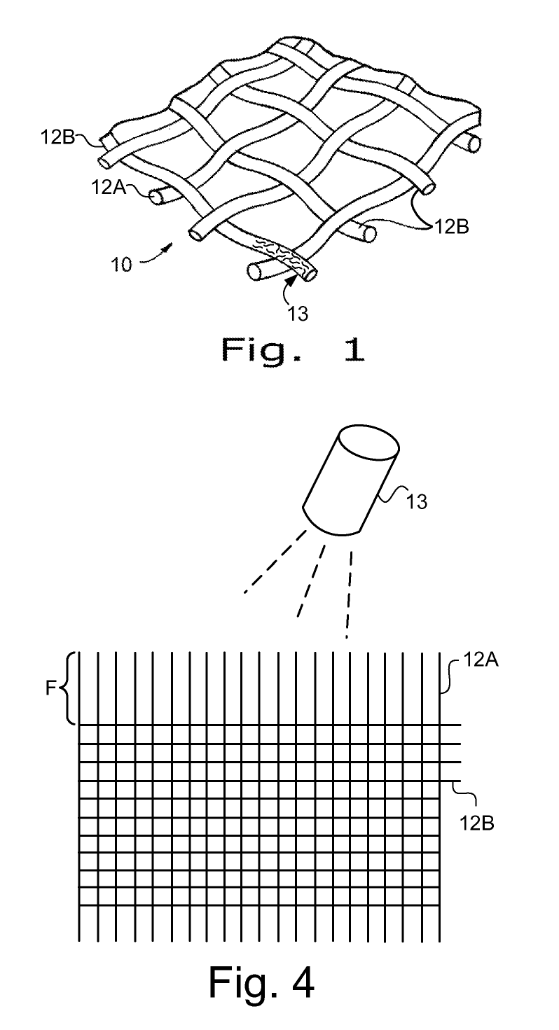

Referring now to the drawings, and more particularly to FIG. 1, there is shown a portion of an embodiment of a PMC fabric 10 including a plurality of woven monofilament yarns, namely warp yarns 12A extending in the running or machine direction, and weft yarns 12B extending in the cross-machine direction. The specific configuration of fabric 10 may vary, depending upon the application. For example, the specific weave pattern of fabric 10 may vary from one application to another.

Monofilament yarns 12A and 12B have a composition which is a mixture of a thermoplastic resin, and an additive to improve yarn visibility, and may contain another additive, such as a carbon-based filler. It is known by the assignee of the present invention to add a carbon-based filler in the form of carbon nanotubes (CNT) and/or nano-graphene to a resin. For example, U.S. patent application Ser. No. 12/976,674, which is assigned to the assignee of the present invention and incorporated herein by reference, discloses adding CNT to a thermoplastic resin in the form of polyethylene terephthalate (PET). Moreover, U.S. patent application Ser. No. 13/177,117, which is assigned to the assignee of the present invention and incorporated herein by reference, discloses adding nano-graphene to a thermoplastic resin in the form of PET. These carbon-based fillers add desirable physical properties to the resin (e.g., abrasion resistance, thermal conductivity, etc) without changing other physical properties of the PET alone (e.g., tenacity, modulus, etc.). Referring to FIG. 1, and for illustrative purposes only, a portion of one of the weft yarns 12B is shown with CNTs 13.

In order to more easily see the individual yarns of the PMC fabric during a seaming process, an additive is added during the monofilament yarn making process. This additive makes the yarn easily visible. More specifically, PMC fabric 10 is formed from a plurality of monofilament yarns 12, for example woven yarns, including an additive, for example a UV additive manufactured by Eastman Chemicals as Eastobrite OB-1™, loading of between approximately 100 to 10,000 parts per million (ppm), for example 1,000 ppm, which makes the fringe at opposite ends of PMC fabric 10 easily visible under black light (which generally emits radiation at wavelengths between approximately 350 nm and 390 nm) while weaving the fringe during a seaming process. The inclusion of an additive is especially useful for fine diameter yarns (below 0.25 mm) and dark colored monofilament yarns (L* value less than 50) which are harder to see with the human eye. A color measurement system, such as CIE L*a*b* or the Yellowness index, can be used to quantify the darkness of the yarn.

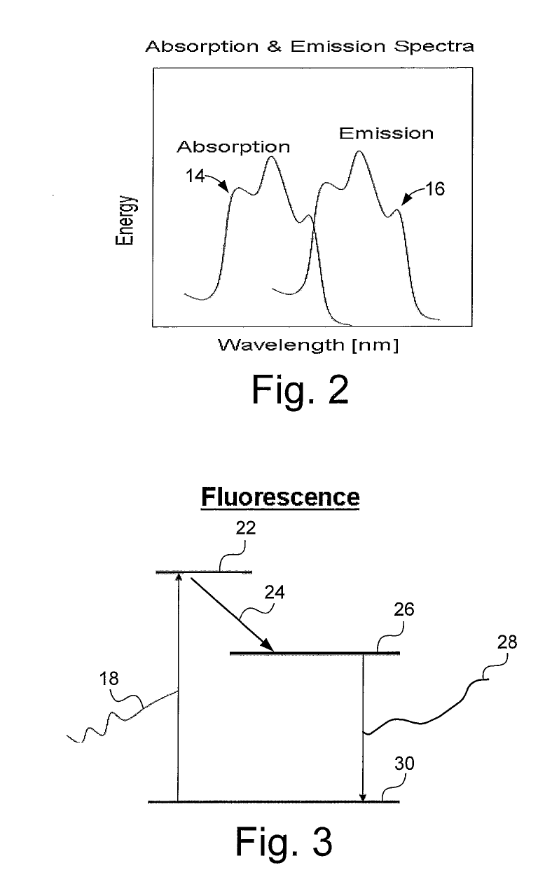

A UV additive, also known as an optical brightener (OB) or fluorescent whitening agent absorbs the short wavelength electromagnetic radiation from a radiation source, such as a black light having a wavelength, e.g., between approximately 300 nm and 400 nm, which is invisible to the human eye and converts it into visible light of a longer wavelength, for example between approximately 400 nm and 500 nm, which is emitted either as violet, blue or greenish blue light. This principle is generally illustrated in FIG. 2, which illustrates absorption 14 and emission 16 spectra as they relate to energy and wavelength.

Fluorescent whitening agents are compounds that are excited or activated by wavelengths in the near-UV range, for example having a wavelength between approximately 360 nm and 365 nm, and then emit light in the blue range, for example having a wavelength between approximately 400 nm and 440 nm. Electrons in fluorescent molecules are excited into a higher energy state by absorption of light, which then emit a small amount of heat plus fluorescence as the electrons return to their ground state. FIG. 3 illustrates this general principle via the application of wavelengths of light 18 in the near-UV range, for example between approximately 360 nm and 365 nm, to a molecule of fluorescent whitening agent 20 which thereby activates the fluorescent whitening agent by exciting the electrons of the fluorescent molecules, raising them to a higher energy state 22 by absorption of light 18, which then results in the emission of a small amount of heat 24 and a second lower excited state 26 plus fluorescence 28 as the electrons of the fluorescent molecules return to their ground state 30, which is the lowest energy state of the molecule.

Fluorescent whitening agents as described above exhibit the property of fluorescence, in that they only emit light while exposed to an electromagnetic radiation source, such as visible light or X-rays. However, it is to be understood that other types of additives such as those that exhibit phosphorescence may be added to the thermoplastic resin used in making yarns 12A and/or 12B. A phosphorescent material emits light for a period of time upon exposure to and removal of electromagnetic radiation (sometimes referred to as “glow-in-the-dark” materials).

FIG. 4 illustrates a schematic view of a portion of a PMC fabric 10 with the fringed end being illuminated with a radiation source in the form of a UV light 13. It will be appreciated that to make a PMC fabric 10 endless, opposite ends of the PMC fabric 10 are fringed to define a fringe area F with exposed warp yarns 12A of a predetermined length. Only one end of PMC fabric 10 with a fringed area F is shown in FIG. 4 for simplicity sake, the opposite fringed end being substantially identical. At least the warp yarns 12A include the UV additive to be easily visible during the seaming process; however, weft yarns 12B may also include the UV additive. The fringed warp yarns 12A of the adjacent fringed ends are woven together during the seaming process to define a seam and thereby make PMC fabric 10 endless.

### EXAMPLE 1

A sample PET-CNT monofilament yarn without a UV additive was compared with a PET-CNT monofilament yarn including a UV additive. Table 1 shows some of the physical properties of the PET-CNT monofilament used for a PMC Dryer Fabric. The control sample (with no UV additive) is shown in the first column and the properties of the yarn with the UV additive, 1000 ppm loading, are shown in the second column. Table 1 shows that the physical properties of the PET-CNT yarn with the UV additive are substantially the same as the PET-CNT monofilament without the UV additive. Therefore, it is clear that the UV additive according to the present invention does not substantially alter the physical properties of the monofilament yarn.

TABLE 1

| | PET-CNT | PET-CNT |
|---|---|---|
| | (Control) | (UV additive 0.1%) |
| Tenacity | 6.0 | 5.9 |
| (grams/den) | | |
| Elongation | 12.7 | 12.9 |
| (%) | | |
| Modulus | 145.0 | 144.0 |
| (grams/den) | | |
| Shrink Force | 197.0 | 194.0 |
| (grams) | | |
| Shrinkage | 13.7 | 13.8 |
| (175 C) | | |
| Abrasion Cycles | 3385 | 3325 |

In Table 2, multiple dark colored yarns were measured using the CIE L*a*b* color measurement system to determine the resulting L* value. The L* parameter is a measure of the lightness of a color with a L* value of 100 representing a white color and a L* value of 0 representing a black color. The L* values shown in Table 2 were measured from dark colored yarns.

TABLE 2

| | Range of L * values based on CIE L * a * b * test |
|---|---|
| Yarn color | method |
| Red | 37.9-43.6 |
| Blue | 34.9-40.8 |
| Black | 17.0-17.1 |

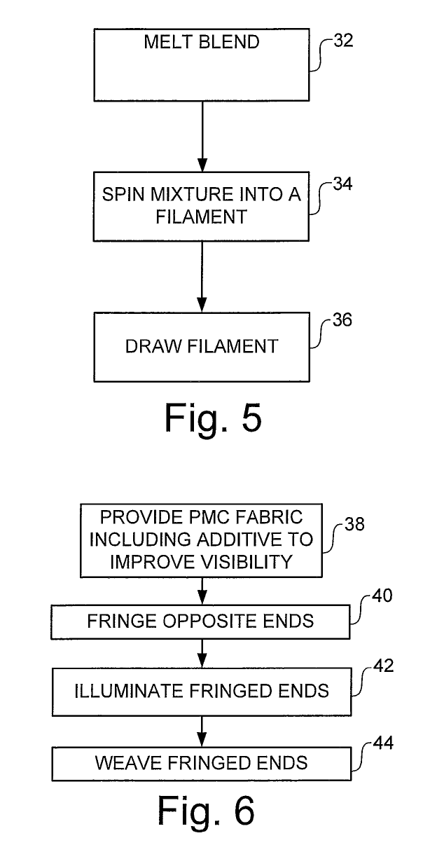

During the manufacture of PMC fabric 10, a screw extruder is used to melt blend a mixture of thermoplastic resin (preferably PET), a carbon-based filler (e.g., CNT and/or nano-graphene), and a UV additive (e.g., a stilbene). (FIG. 5, block 32). The mixture is then spun into a filament (block 34). The filament is then subsequently drawn into a monofilament PMC fabric yarn with at least one predetermined physical property (block 36). The PMC fabric yarn is then woven into PMC fabric 10.

During a seaming process of the present invention, a PMC fabric is provided which includes a plurality of monofilament yarns, at least some of which include between approximately 100 ppm to 4,000 ppm of a UV additive. (FIG. 6, block 38). Opposite ends of the PMC fabric are fringed by removing filling yarns at the respective opposite ends (block 40). The fringed ends of the PMC fabric are illuminated using short wavelength radiation at a wavelength of between approximately 300 nm to 400 nm (block 42). The fringed ends of the illuminated PMC fabric are woven together to complete the seam (block 44).

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A paper machine clothing (PMC) fabric including a plurality of monofilament yarns, at least some of said monofilament yarns having a composition which is a mixture of a thermoplastic resin and an additive to improve yarn visibility.

2. The PMC fabric according to claim 1, wherein the additive is at least one of a UV additive, an IR additive, and a metal powder additive.

3. The PMC fabric according to claim 1, wherein said plurality of monofilament yarns include a plurality of warp yarns and a plurality of weft yarns, and all of said warp yarns include said additive.

4. The PMC fabric according to claim 1, wherein at least some of said monofilament yarns include between approximately 100 to 10,000 parts per million (ppm) of said additive.

5. The PMC fabric according to claim 4, wherein at least some of said monofilament yarns include approximately 1,000 ppm loading of said additive.

6. The PMC fabric according to claim 1, wherein said additive is a stilbene.

7. The PMC fabric according to claim 6, wherein said stilbene is 4,4′-bis (benzoxazol) stilbene.

8. The PMC fabric according to claim 1, wherein said PMC fabric includes a plurality of woven yarns.

9. The PMC fabric according to claim 8, wherein said plurality of woven yarns have one of a diameter and minor axis dimension of 0.90 mm or less.

10. The PMC fabric according to claim 9, wherein said plurality of woven yarns have one of a diameter and minor axis dimension of 0.70 mm or less.

11. The PMC fabric according to claim 8, wherein said plurality of woven yarns have an L* lightness value of 50 or less.

12. The PMC fabric according to claim 1, wherein at least some of said monofilament yarns having a composition including a carbon-based filler.

13. The PMC fabric according to claim 12, wherein said carbon-based filler includes at least one of carbon nanotubes (CNT) and nano-graphene.

14. The PMC fabric according to claim 1, wherein said thermoplastic resin is polyethylene terephthalate (PET).

15. The PMC fabric according to claim 14, wherein said composition has a tenacity which is approximately the same as said PET alone.

16. The PMC fabric according to claim 14, wherein said composition has a relative elongation which is approximately the same as said PET alone.

17. The PMC fabric according to claim 14, wherein said composition has a loop strength which is approximately the same as said PET alone.

18. A paper machine clothing (PMC) fabric yarn comprising a monofilament yarn with a composition which is a mixture of a thermoplastic resin and an additive to improve yarn visibility.

19. The PMC fabric yarn according to claim 18, wherein the additive is at least one of a UV additive, an IR additive, and a metal powder additive.

20. The PMC fabric yarn according to claim 18, wherein said monofilament yarn includes between approximately 100 to 10,000 parts per million (ppm) of said additive.

21. The PMC fabric yarn according to claim 20, wherein said monofilament yarn includes approximately 1,000 ppm loading of said additive.

22. The PMC fabric yarn according to claim 18, wherein said additive is a stilbene.

23. The PMC fabric yarn according to claim 22, wherein said stilbene is 4,4′-bis (benzoxazol) stilbene.

24. The PMC fabric yarn according to claim 18, wherein said monofilament yarn has a composition including a carbon-based filler.

25. The PMC fabric yarn according to claim 24, wherein said carbon-based filler includes at least one of carbon nanotubes (CNT) and nano-graphene.

26. The PMC fabric yarn according to claim 18, wherein said thermoplastic resin is polyethylene terephthalate (PET).

27. The PMC fabric yarn according to claim 18, wherein said monofilament yarn has one of a diameter and minor axis dimension of 0.90 mm or less.

28. The PMC fabric yarn according to claim 27, wherein said monofilament yarn has one of a diameter and minor axis dimension of 0.70 mm or less.

29. The PMC fabric yarn according to claim 18, wherein said monofilament yarn has an L* lightness value of 50 or less.
